(19) United States
(12) Patent Application Publication
(10) Pub. No.: US 2006/0163380 A1
(43) Pub. Date: Jul. 27, 2006

(54) High flow particles atomizer

(75) Inventor: Kang-Ho Ahn, Seoul (KR)

Correspondence Address: LOWE HAUPTMAN BERNER, LLP, 1700 DIAGONAL ROAD, SUITE 300, ALEXANDRIA, VA, 22314, US

(73) Assignee: A & P SCIENCE CO., LTD., Seoul (KR)

(21) Appl. No.: 10/544,915

(22) PCT Filed: Feb. 10, 2004
(86) PCT No.: PCT/KR04/00261

§ 371 Date: Aug. 9, 2005

(30) Foreign Application Priority Data
Feb. 10, 2003 (KR) 10-2003-0008199

(51) Int. Cl. B05C 1/00

(52) U.S. Cl. 239/135; 239/128; 239/338; 239/340; 239/408

(57) ABSTRACT

The present invention relates to a high flow particles atomizer for atomizing a liquid and drying atomized particles to produce the atomized particles at high flow rate. The atomizer of the present invention comprises a container for containing liquid to be atomized, a nozzle positioned at the center above a liquid surface of the liquid contained in the container for injecting a large amount of gas, a liquid supply device for supplying the liquid into the gas injected by the nozzle, and an atomized particle discharge tube communicating with the container for allowing atomized particles injected by the nozzle to be discharged to the outside of the container. In addition, the atomizer further comprises a drying device for drying the atomized particles discharged through the atomized particle discharge tube.

### TECHNICAL FIELD

The present invention relates to a high flow particles atomizer, and more particularly, to a high flow particles atomizer for atomizing liquid and drying atomized particles to produce the atomized particles at high flow rate.

### BACKGROUND ART

As is well known in the art, a particle atomizer is an apparatus for causing liquid to be dispersed into high flow particles by means of the atomization of the liquid and causing the moisture contained in the atomized particles to evaporate in order to produce dry fine particles. Such a particle atomizer has been developed into a pressure type, a rotary type, a twin-fluid type, an electrostatic type, an ultrasonic type and the like according to their various types and structures.

Particle atomizers are generally used in filtration efficiency tests of high performance filters such as HEPA filters (High Efficiency Particulate Air filters) capable of filtering out particulates having a size of 0.3 μm and ULPA filters (Ultra Low Penetration Air filters) capable of filtering out particulates having a size of 0.1˜0.12 μm. To reduce the time required for these tests, such a particle atomizer should be able to produce the particles at high flow rate.

However, conventional particle atomizers comprise a number of parts for the supply and atomization of liquid to produce particles at high flow rate. Thus, there are some disadvantages in that conventional particle atomizers are complex and expensive. Furthermore, there are many problems in that they are not suitable for filter tests because particles are produced slowly in conventional particle atomizers and its utility is low due to the long test time.

### DISCLOSURE OF INVENTION

Accordingly, the present invention is conceived to solve the aforementioned problems in the prior art. An object of the present invention is to provide a particle atomizer for efficiently producing particles at high flow rate by using a simplified structure.

According to an aspect of the present invention for achieving the object, there is provided a high flow particles atomizer comprising a container for containing liquid to be atomized, an injection device positioned at a center above a liquid surface of the liquid contained in the container for injecting a large amount of gas, a liquid supply device for supplying the liquid into the gas injected by the injecting device, and an atomized particle discharge tube communicating with the container for allowing atomized particles injected by the injection device to be discharged to outside of the container.

### BRIEF DESCRIPTION OF DRAWINGS

FIG. 1 is a sectional view illustrating the configuration of a high flow particles atomizer according to the present invention.

FIG. 2 is a sectional view taken along line II-II of FIG. 1.

FIG. 3 is a sectional view taken along line III-III of FIG. 1.

FIG. 4 is a sectional view illustrating the operation of the high flow particles atomizer according to the present invention.

### BEST MODE FOR CARRYING OUT THE INVENTION

Hereinafter, a preferred embodiment of a high flow particles atomizer according to the present invention will be described in detail with reference to accompanying drawings.

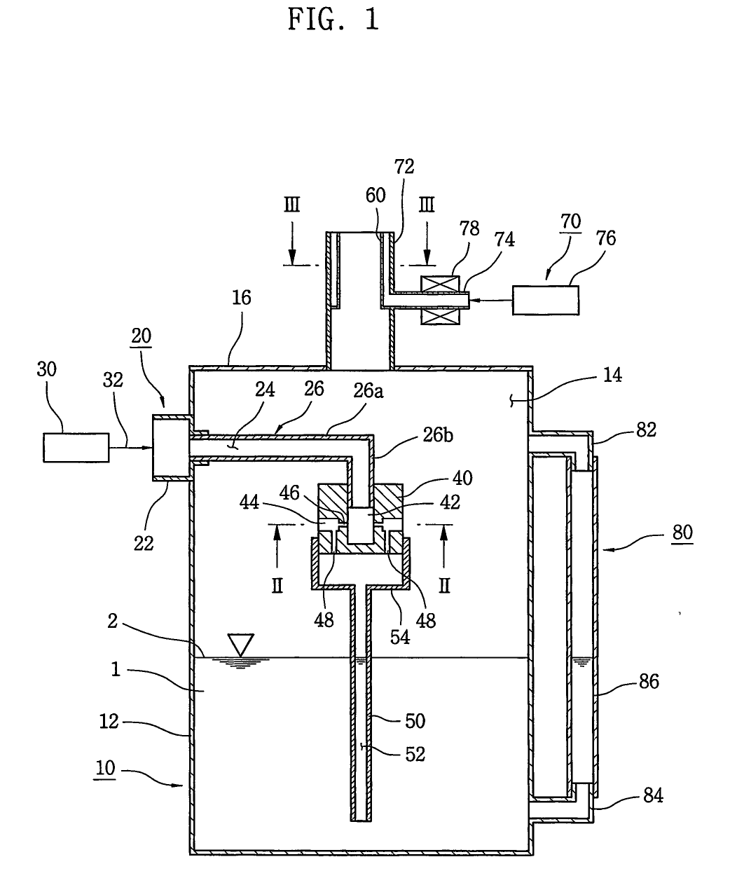

First, referring to FIG. 1, the atomizer of the present invention includes a container 10 made of metal such as stainless steel for containing liquid 1 to be atomized, for example, polystyrene latex particle solution, oil and the like. A cover 16 for covering a receiving chamber 14 is attached to an upright container body 12 of the container 10. A gas inlet tube 20 is connected to an external surface of the container body 12 such that a gas, e.g. a high-pressure air or gas, can be introduced over a liquid surface 2 of the liquid 1 at a center of the receiving chamber 14.

The gas inlet tube 20 comprises an adapter 22 and a connection tube 26. The adapter 22 is mounted through the external surface of the container body 12 to provide a pipeline 32 into the adapter 22. The connection tube 26 is connected to the adapter 22 and defines a gas passage 24 such that the gas can be introduced into the center of the container body 12 through the adapter 22. Further, the connection tube 26 is has a horizontal tube section 26a and a vertical tube section 26b extending vertically and downward from a distal end of the horizontal tube section 26a. The vertical tube section 26b is aligned with a vertical central axis of the container body 12. A gas supply device 30 may comprise a general air compressor for generating and supplying high-pressure air and an air controller for controlling the flow rate and pressure of the air supplied from the air compressor.

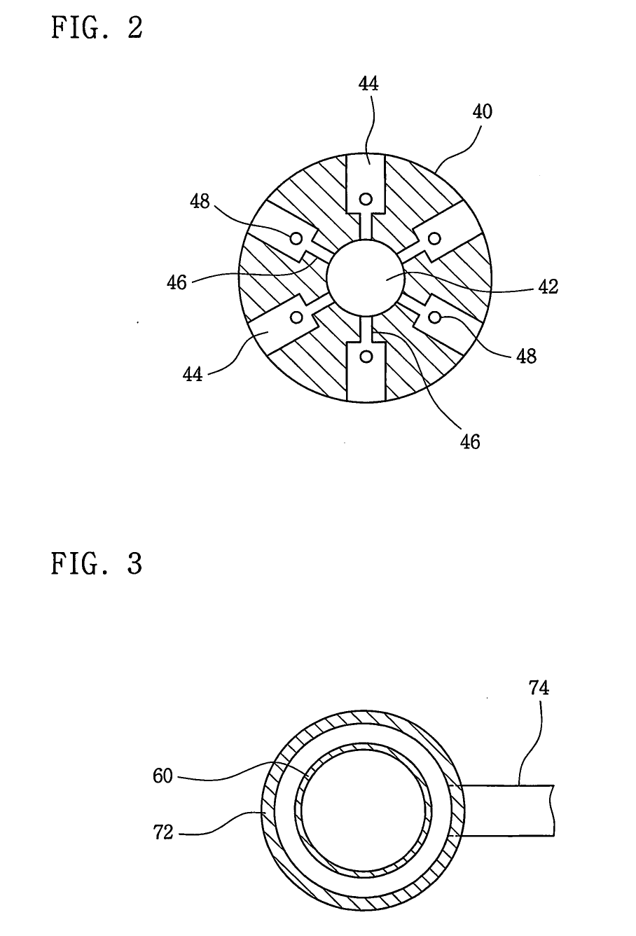

Referring now to FIGS. 1 and 2, the vertical tube section 26b of the gas inlet tube 20 is mounted with a nozzle 40 which is located at the center above the liquid surface 2 of the liquid 1 and serves as an injecting device for injecting a large amount of gas into the receiving chamber 14 of the container body 12. The nozzle 40 is formed with a passage 42 communicating with the passage 24 of the gas inlet tube 20 at the center thereof, and a plurality of nozzle holes 44 are radially formed in the nozzle 40 to communicate with the passage 42 through relevant throats 46, respectively. Further, a suction port 48 is formed on the bottom of the inner surface of each of the nozzle holes 44. Although it is shown in FIG. 2 that six nozzle holes 44 are formed at equal intervals, it is merely illustrative and the number and location of the nozzle holes 44 may be changed.

In addition, the suction ports 48 of the nozzle 40 is in communication with a supply tube as a liquid supply device for supplying the liquid 1 contained in the container body 12. The supply tube has a passage 52 and a head section 54. The head section 54 of the liquid supply tube 50 is coupled to the lower portion of the external surface of the nozzle 40 such that the passage 52 can communicate with the suction ports 48 of the nozzle 40, and the lower end of the liquid supply tube 50 extends close to the bottom of the container body 12.

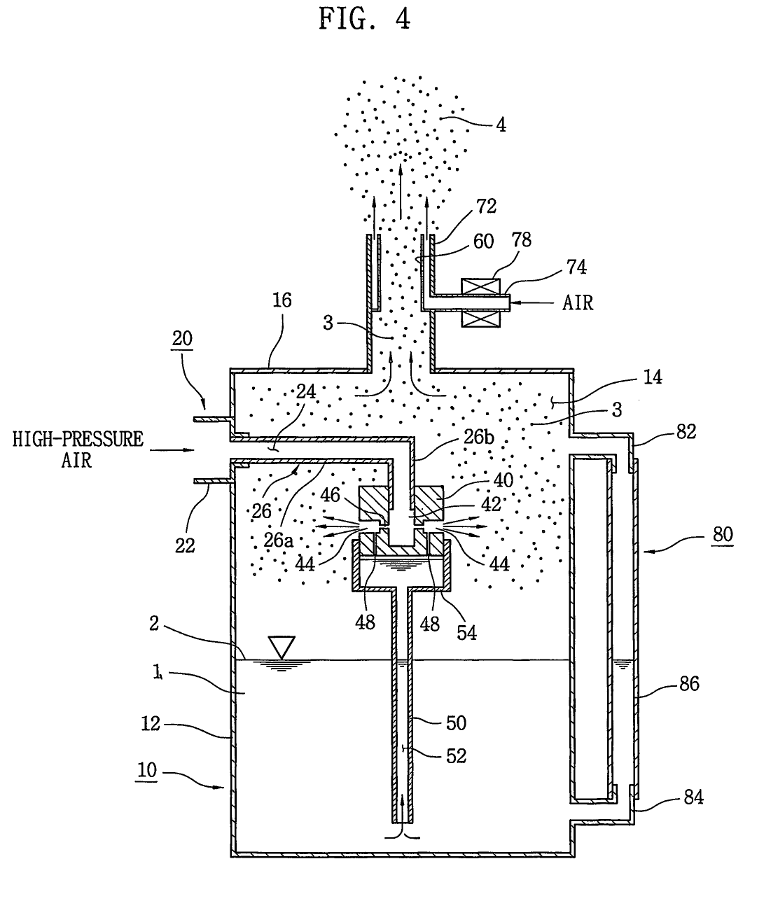

Referring to FIGS. 1 and 3, the atomizer of the present invention further includes an atomized particle discharge tube 60 and a drying device 70. The atomized particle discharge tube 60 is arranged at the center of the cover 16 in such a manner that it can communicate with the receiving chamber 14 of the container body 12 to discharge atomized particles 3 to the outside. The drying device 70 allows moisture in the atomized particles 3 discharged through the atomized particle discharge tube 60 to be removed and then formed into dry particles 4.

The drying device 70 comprises a hot wind injecting tube 72 which surrounds the atomized particle discharge tube 60 to be concentric therewith, a hot wind supply tube 74 connected to the hot wind injecting tune 72, an air blower 76 for supplying air into the hot wind supply tube 74, and a heater 78 for providing heat to the air supplied through the hot wind supply tube 74 to produce hot wind. The air blower 76 of the drying device 70 may be replaced with an air compressor and air controller. The heater 78 may be constructed in the form of heating wires wrapped around an external surface of the hot wire supply tube 74.

Referring again to FIG. 1, a liquid level meter 80 for allowing a level of the liquid 1 contained in the receiving chamber 14 to be viewed from the outside is installed on the outer side of the container body 12. The liquid level meter 80 comprises upper and lower connection tubes 82 and 84, and a transparent viewing tube 86 connected to the upper and lower connection tubes 82 and 84. Further, a scale is marked on an external surface of the viewing tube 86 to allow the level of the liquid surface 2 to be checked.

Hereinafter, the operation of the high flow particles atomizer according to the present invention so configured will be described.

Referring to FIGS. 1 and 4, an operator opens the cover 16 of the container 10, fills the required amount of liquid 1 into the receiving chamber 14 of the container body 12 such that the nozzle 40 does not submerge, and then closes the cover 16. The level of the liquid 1 contained in the receiving chamber 14 of the container 10 can be easily checked through the viewing tube 86 of the liquid level meter 80.

Next, if high-pressure air produced by the operation of the gas supply device 30 is supplied into the passage 42 of the nozzle 40 through the adapter 22 and connection tube 26 of the gas inlet tube 20, the supplied air passes through the throats 46 and is discharged into the receiving chamber 14 through the nozzle holes 44. If the air is discharged through the nozzle holes 44 of the nozzle 40 at high speed, a lower pressure is created above inlet portions of the suction ports 48 according to the Bernoulli theorem. Therefore, the liquid 1 to be atomized is sucked up into the inlet portions of the suction ports 48 through the passage 52 of the liquid supply tube 50.

Subsequently, the liquid 1 supplied into the nozzle holes 44 through the passage 52 of the liquid supply tube 52 and the suction ports 48 of the nozzle 40 is atomized into the atomized particles 3 by means of the high-speed air passing through nozzle holes 44 and the atomized particles 3 are then injected radially into the receiving chamber 14. At this time, the atomized particles 3 are produced at high flow rate in the respective nozzle holes 44. As the high-speed air is continuously supplied into the receiving chamber 14 of the container 10, a pressure in the container 10 is increased and thus the atomized particles 3 in the receiving chamber 14 are discharged to the outside through atomized particle discharge tube 60.

In addition, the air blower 76 of the drying device 70 operates to supply air through the hot wind supply tube 74, and the heater 78 operates to heat the air passing through the hot wind supply tube 74 and to produce a hot wind. To remove moisture from the atomized particles 3, the hot wind from the hot wind supply tube 72 comes into contact with the atomized particles discharged through the atomized particle discharge tube 60. Dried particles 4 from which the moisture has been removed are used in filter tests for HEPA filters and ULPA filters.

### INDUSTRIAL APPLICABILITY

According to a high flow particles atomizer of the present invention as described above, a liquid in the receiving chamber can be atomized into particles by supplying and injecting the liquid into the nozzle holes while injecting high-speed air into the receiving chamber of the container through the nozzle holes of the nozzle, and the atomized particles can be efficiently produced at high flow rate by drying the atomized particles discharged to the outside of the container. Further, since the atomized particles can be produced at high flow rate by using a nozzle having a single structure, the number of parts of the atomizer is reduced and thus its structure is also simplified. Therefore, there is an advantage in that the atomizer can be competitive in view of their prices due to the improvement on productivity and the reduction in production costs.

The aforementioned preferred embodiment is merely for the purpose of illustrating the present invention, but for the purpose of restricting the scope of the present invention. It is apparent to those skilled in the art that various changes, modifications and substitutions can be made thereto without departing from the spirit and scope of the present invention. Accordingly, the scope of the present invention is defined by the appended claims, and all changes, modifications and substitutions should be construed as falling within the scope of the present invention.

1. A high flow particles atomizer, comprising:
a container for containing liquid to be atomized;
an injection means positioned at a center above a liquid surface of the liquid contained in the container for injecting a large amount of gas;
a liquid supply means for supplying the liquid into the gas injected by the injecting device; and
an atomized particle discharge tube communicating with the container for allowing atomized particles injected by the injection means to be discharged to outside of the container.

2. The atomizer as claimed in claim 1, wherein the injection means includes a nozzle which communicates with a gas inlet tube penetrating through the container for introducing the gas therein, and the nozzle includes a plurality of radial nozzle holes and suction ports which communicate with each of the nozzle holes and are connected to the liquid supply means.

3. The atomizer as claimed in claim 1, further comprising a drying means for drying the atomized particles discharged through the atomized particle discharge tube.

4. The atomizer as claimed in claim 3, wherein the drying means comprises:
a hot wind injecting tube surrounding the atomized particle discharge tube to be concentric therewith;
a hot wind supply tube connected to the hot wind injecting tube;
an air blower for supplying air into the hot wind supply tube; and
a heater for heating the air supplied through the hot wind supply tube to produce hot wind.

5. The atomizer as claimed in claim 1, further comprising a liquid level meter capable of showing a level of the liquid contained in the container.
